(19) United States
(12) Patent Application Publication
(10) Pub. No.: US 2019/0223991 A1
(43) Pub. Date: Jul. 25, 2019

(54) DEVICE FOR CLEANING TEETH AND GUMS

(71) Applicant: Karl-Josef KRAMER, Livermore, CA (US)

(72) Inventor: Karl-Josef Kramer, Livermore, CA (US)

(73) Assignee: Karl-Josef Kramer, Livermore, CA (US)

(21) Appl. No.: 16/333,088

(22) PCT Filed: Oct. 4, 2017
(86) PCT No.: PCT/US2017/055030

§ 371 Date: Mar. 13, 2019

Related U.S. Application Data
(60) Provisional application No. 62/404,364, filed on Oct. 5, 2016.

(51) Int. Cl. A61C 17/02; A61C 17/20

(52) U.S. Cl. CPC A61C 17/0211; A61C 17/0208; A61C 17/20; A61C 17/0205

(57) ABSTRACT

A cleaning device provides for quick, thorough and pleasant multi-parallel cleaning of teeth and gums through use of a pressurized cleaning liquid, applied to teeth and gums by a cleaning headpiece with a plurality of cleaning nozzles and with optimized and practical geometry as well as readily applicable control of the clean by the user. Sensations of suffocating or drowning, which can be serious detriments and hindrances of prior art devices, are effectively overcome. In a preferred embodiment, teeth are cleaned in two steps, where each step cleans the teeth and gums in just over one side of the user's jaws. The device can simply be extracted, flipped by 180 degrees and reinserted into the mouth between the two steps.

### CROSS-REFERENCE TO RELATED APPLICATIONS

This application claims priority to U.S. Provisional Application Ser. No. 62/404,364, filed Oct. 5, 2016, which is hereby incorporated by reference in its entirety.

### FIELD

The present technology relates to devices for cleaning teeth and gums.

### BACKGROUND

For the longest time, tooth brushes, typically with bristles, have been far and above the most used cleaning devices for teeth.

Such tooth brushes, even though they have undergone multiple redesigns including e.g. electrical agitation, all rely on the user to reach all areas of their teeth and gums in a sequential effort. It is well known that specific areas are tougher to reach and consequently receive less cleaning attention. For instance, but not limited to, lingual regions in the posterior of the mouth are tougher to reach than, say, labial anterior regions. Also, tooth brushes tend to provide insufficient access to the spaces between teeth. This has led to the development of flossing strings, with its own progressions of development. Such flossing needs to be done in addition to teeth brushing and is tedious as well as can easily lead to bleeding gums. It is equally prone to omitting tough to reach regions. Some devices using single water jets instead of tooth flossing string have been developed and are on the market. These devices tend to have a single point of application which the user has to move from point to point to apply throughout their mouth.

In all these classic and very widespread methods have serious limitations, while at the same token taking a lot of time per use cycle.

Through the years, several mitigations have been proposed, which so far have not enjoyed large commercial success. Some such mitigations tend to propose U-shaped applicators with a multitude of holes.

These U-shaped applicators tend to have a shallow H-shaped cross-section. Some of these devices apply a liquid through these holes and optionally provide an extraction tube, such as tubes that dentists typically use during procedures to remove liquid from the patient's mouth.

There are still several issues with devices like these. For instance, a proper U-shaped device with a sufficiently high H-shaped cross-section is tedious and indeed can be painful to insert into and remove from a user's mouth. It can also cause a very uncomfortable sensation of suffocation, as a sensation akin to that of gagging can potentially be felt.

In addition, the use of excess water, even when pulsed, can lead to a sensation akin to drowning for the user.

However, the multitude of holes typically requires the use of a large amount of water, to the extent that it is not comfortable for the user.

In addition to U-shaped devices with a multitude of nozzles, also J-shaped devices, covering one side of a jaw, have been proposed.

Designs proposed to date which use a simultaneous plurality of cleaning fluid nozzles have not gained much traction with respect to widespread acceptance and usage. This is due mainly to the fact that they tend to suffer from one or more of the following issues:

Sensation of suffocation by drowning, excess water supply to the user's mouth leading to reduced impact of the fluid jets, as the present water reduces the impact of freshly delivered fluid, overambitious designs that try to actively remove liquid at the rate of injecting it, thereby complicating the geometries; the uniqueness of each individual's jaw and the effort and the associated cost to deliver a solution that fits to the individual; poor design of fluid distribution, leading to highly non-uniform fluid pressure distribution and therefore non-uniform cleaning results; device material selection that compromises manipulation of location of the device against sustainable fluid pressure and delivery performance.

### SUMMARY

The present technology seeks to overcome one or more of the limitations seen in devices with a plurality of pressurized cleaning fluid orifices that have been proposed to date. It also seeks to make the cleaning experience a very fast, pleasant and low effort undertaking and thereby seeks to increase the likelihood that the user makes this procedure their regular habit, with repeatable and controllable significant cleaning results. The present technology seeks to provide a solution to one or more of the problems described above, by providing a cleaning device that has in one embodiment essentially a J-shaped cleaning device head, which is also called headpiece herein, and which contains multiple cleaning nozzles or orifices. It has tubing attached through which pressurized liquid can be applied and has a handle for the user, said handle containing an actuator for liquid flow, with a sufficiently tall H cross section, with enough cleaning liquid orifices to address all areas and crevices. The actuator is preferably a normally closed valve that is actuated and permits liquid delivery to the headpiece only as long it is actively engaged by the user. Optionally, the handle can contain a plurality of such actuators which all need to be actively engaged by the user. This brings a redundancy and enables a rapid cut-off of liquid to the mouth at any time the user desires. The H-shaped cross section is large enough so that the user can manipulate, using the handle, the position of the J-shaped device head in their mouth and thus address all locations in parallel very quickly.

In one preferred embodiment the device contains, in the bridge of the H cross section, resilient flexures that the user can actuate by gently biting down and by this action, address different heights within his or her teeth to direct the plurality of fluid jets onto. Said resilient flexures allow for good control of the location and direction of the pressurized nozzles, while the chosen rigid material selected for the headpiece core, for instance fiber reinforced plastics or metal is able to sustain, the necessary high liquid pressure within the headpiece for high and uniform fluid pressure and liquid flow across all cleaning nozzles of the headpiece. The headpiece can be made from a metal core for most of the fluid paths and covered by a preferably injection moldable plastic or plastic—fiber composite, or, preferable from an economic point of view the headpiece can be comprised wholly of a sufficiently strong and nontoxic plastic—fiber composite. Proposed materials are nylon/polyamide, polypropylene, polyethylene as well as such materials reinforced by fibers, fibers being for instance glass fibers, such as reinforced Ultramid®, Ultradur® or other polyamide based materials. However, several injection moldable materials are suitable. A key enabler here is the combination of strong material for the headpiece which can withstand substantial internal liquid pressures which is beneficial to provide sufficiently high pressure and high and even pressure and flow distribution with flexible, compliant materials used for flexures and/or bristles, which enable the user to finely control the position of the headpiece within the user's mouth.

Both the use of a handle and the use of flexures essentially allow the user to simply and conveniently direct the various jets to desired positions, which brings with it the significant advantage that such an arrangement requires far fewer orifices and thus far less water to be directed into the user's mouth at any time, compared to a device for which the multitude of orifices during the cleaning process are more or less stationary with respect to the position of the teeth.

In addition, the J-shaped device headpiece's cross section is arranged such that the curvature of the J in the anterior region allows for addressing at least half of the anterior teeth or just a little further. Also, the headpiece is desired to fit sufficiently loosely in the user's mouth to, for one accommodate several locations by being moved throughout the mouth during the cleaning treatment, but also to be compatible with a large range of varying human dental anatomy. It is envisioned that the device is available in a reasonable number of sizes (e.g. between 2 and 20) and users can re-order or re-purchase the size that fits them best.

Using such a relatively small number of different sizes of headpieces enables the use of mass-injection molded headpieces which in turn enable widespread economic acceptance of such a device as it overcomes the issue of individually adapting headpieces to a user's mouth, as is for instance commonly done for a large array of dental work. However, such individual adaptation, albeit at higher device cost, is also envisioned as part of this disclosure.

The cleaning is accomplished in two steps. First by inserting the J-shaped device on one side, e.g. the left side of the jaw, and applying the cleaning routine (water pressure, handle motions, optional gentle flexure biting motions). Second, by flipping the device by 180 degrees and applying it to the right side of the jaw and repeating said cleaning routine.

In doing so, the part of the device that cleaned for instance the left lingual (and mesial) maxillary tooth surfaces in the first step is now cleaning the right lingual (and mesial) mandibular tooth surfaces and so forth.

This suggests that in a preferred embodiment the H cross section of the headpiece would benefit from a top to bottom symmetry and from a sufficiently wide H bridge width to accommodate the difference between the extent of the maxillary and mandibular jaws. Some accommodation can be made by the user by moving e.g. their lower jaw sideways substantially underneath their upper jaw.

Said accommodation is only possible since an essentially J-shaped and not an essentially U-shaped cleaning device head is used.

Said J-shaped device head also requires, for the same cleaning action, about half the water as a U-shaped device to be applied at any point in time, therefore greatly alleviating the risk and discomfort of drowning sensations.

Also, the J-shaped device head is much more readily inserted into the user's mouth than a U-shaped device, since the mouth opening of the average user tends to be less wide than the posterior part of the user's jaw. And in addition to that, the H-shaped cross-section all but demands—for a U-shaped device the need to be even wider than the largest posterior maxillary jaw width.

It is to be noted that all edges of the headpiece or device head are preferably rounded off to reduce any discomfort and remove any risk of the user cutting themselves along sharp edges. Towards the rear of the jaw it can be preferable to have a lower H-profile height than close to the front, as this can help accommodate the device in the jaw. In addition most users will have their rear molar teeth with a lower height extending from the gum line than the front teeth.

The handle on the device allows for the user to very readily control the application of the device and is best connected to the headpiece in a substantially rigid way, in order to exert good location control for the headpiece.

In a preferred embodiment the handle contains an actuator such as a switch (such as an intuitive push-button) on the handle, so that the user can control the application of the pressurized liquid in an instant. In one preferred embodiment the water only flows while the push button (which can be for instance spring loaded) is actuated. In another embodiment, a bi-stable on-off switch can be used on the handle. In another embodiment, a plurality of push-buttons need to be actuated, preferably by using a plurality of fingers of the same hand that holds the handle, to ensure a redundant fluid cutoff.

In one embodiment said actuator on the handle can also turn the water pressure supply pump on or off, such as to protect the pump from pumping against a closed valve.

Said J-shaped device headpiece design, with sufficiently wide H bridge, allows for easy adjustment to a variety of different jaw sizes. It is, however, envisioned, that in the commercial solution, several J-shaped mouth pieces of different size and perhaps curvature are supplied to the user, so that the user can chose the piece that most closely harmonizes with his or her jaw sizes. For that it is envisioned to have for instance a simple joint at the end of the handle where the different mouth pieces can be attached and detached. Said headpieces could be marked or indexed, so that the user can buy dedicated replacement headpieces in the desired size and shape.

In one embodiment, the device is supplied with a liquid pump that can, for instance, allow for pulsated, adjustable pulsated, or continuous liquid pressure. Especially for pulsed delivery, tubing, handle and headpiece should be manufactured from material that is rigid enough not to excessively absorb and dissipate the pulses by expansion and contraction.

Such a pump can in one embodiment feed from a liquid reservoir, which, in a preferred embodiment, can be filled with water or water plus a cleaning enhancing material, such as a bubbling solution or a fluoride or other desired chemical containing solution or any other water-soluble additive deemed beneficial.

In another embodiment, the pump's suction (supply) side can be attached to a faucet. Said faucet can for instance double as the standard faucet of a sink and have a secondary outlet. Feeding from a faucet to an internal reservoir can also be controlled automatically using a reservoir level sensor and a valve which operates a sealed line from a faucet to said reservoir.

In one embodiment thereof, the additional faucet outlet allows for the use of the temperature mixing capability of said faucet, thereby allowing the user to always have liquid of a suitable temperature, which helps those users with temperature sensitivity of teeth or gums. Said capability is enabled in one embodiment readily by using a liquid diversion device akin to those used for example in bath tubs for redirecting water from a bathtub faucet to a shower faucet, while still utilizing one and the same temperature mixer.

In another embodiment, if the water pressure available at the sink used by the user during the cleaning is sufficient, the need for a pump may not be given and the available faucet water pressure can be applied directly to the handheld piece.

The tubing of the handheld piece is then in one embodiment directly applied to the secondary outlet of said faucet. In another embodiment, the tubing contains a sealable clamping device at the end, which allows for sealing the tubing securely to the standard faucet outlet. Such a setup is also possible in conjunction with the suction side of a pump-assisted setup.

In order to seal securely, faucet geometry has to be suitable (often preferably circular cylindrical or approximately circular cylindrical). In a commercial kit, several sealing ring sizes can be supplied to the customer which facilitates connection to a large range of faucets.

Using water from the faucet, either directly or by diverting it from the faucet to an intermediate container, has the added convenience of not having to handle and fill or refill water containers before or during cleaning.

Intermediate vessels or devices: on the way to the user's mouth, the water or cleaning liquid can be enhanced in its cleaning performance by passing it through a sonic or ultrasonic transducer, which generates bubbles that can help in the cleaning action. Said bubbles can also be generated by using tablets that, when immersed in water, for instance at the liquid reservoir, release gases such as carbon dioxide.

Ultrasonic activation can also be incorporated into the handle, which has a preferably suitably rigid connection to the headpiece.

While ultrasonic transducers can be costly hardware, the cost of tablets as a regular consumable would need to be weighed against that investment. Such choices can either be offered as part of a standard commercial package or as optional higher end devices.

Water drainage from user's mouth: the water can either drain naturally (by gravity) as the user tilts their head accordingly or in one embodiment an additional suction hose can be added to the device, or applied separately to the mouth, as the J-shaped device readily allows for insertion of a suction tube next to the cleaning device. This application is mainly considered when caregivers apply the device to another person rather than users operating the device by themselves.

In another embodiment, the preferably J-shaped cleaning device is attached to a handle which contains a fluid reservoir. Said fluid reservoir can be compressed to a smaller volume and thereby, and preferably by the use of single direction check valves, apply the pressurized fluid to the cleaning device by squeezing the reservoir to a smaller volume. This application requires no electricity and no high-pressure water, as the pressure is generated by the squeezing motion of the user's hand. The pressure is generated readily by compressing from a large volume and surface through the set of small orifices in the cleaning device. Such a compressible reservoir can either be filled repeatedly for instance from a faucet, or it can contain a piece of tubing which, as the user lets the reservoir expand or re-expand, resulting suction can refill the reservoir through said tubing which is connected to a separate reservoir or to a faucet. Said suction is preferably caused by the reservoir's natural tendency to expand back into its original state. The use of check valves enables such action. During the cleaning process, repeated compression and relaxation can move more fluid through the reservoir. However, such a compressible reservoir should allow in a preferred embodiment access to mechanical cleaning of the inside of the reservoir for larger cleaning intervals (e.g. for weekly or monthly reservoir cleaning). The walls of said compressible reservoir can for instance be made from compatible silicone rubber or similar material. Advantage of such a reservoir based system is that the system is easily used in locations where no electricity to supply a pump is available. Note that of course the pump itself can be battery operable as well. Another advantage is that using such a manual reservoir based system easily limits the total amount of liquid applied to the jaw and thus avoids any issue with oversupply of liquid.

In the case that a pump with reservoir is used, one embodiment includes that the cleaning device can be temporarily or permanently stored in said reservoir. By running the pump (and opening the switch on the handle in the respective embodiments) the cleaning device can be cleaned by continuously pumping liquid. This can be done by manual adjustment or for user convenience by applying a self-clean cycle.

In one embodiment the cleaning device also contains bristles in addition to the liquid nozzles (orifices), so that during the cleaning with liquid, a mechanical abrasion force can also be applied.

While the J-shaped device is very well suitable, other geometries can also be employed which share some or all of the benefits:

In one embodiment two opposing J-shaped cleaning device headpieces are attached to the same handle. They can share one tubing for water supply, but the water is directed by a two-way switch into either of the two cleaning device heads. Care needs to be taken to have intuitive switching points. Such a device does not require 180 degrees rotation of the J-shaped headpiece and therefore allows a J-shaped headpiece that is more accommodating to the difference between upper and lower jaw.

Also, in order to overcome the problems with using a U-shaped cleaning device which does not have sufficient height profile on its H-shaped cross section, an additional embodiment allows for the device to be made of essentially two J-shaped headpieces which are hinged close to the center anterior point and are inserted into the mouth in a collapsed or folded shape and then open up inside the mouth to form approximately a U-shape that is essentially conforming to the jaws.

To not rely on 180 degrees flipping of the J-shaped headpiece, it is also envisioned that in one embodiment two symmetrical J shaped headpieces are used and one applied for each side of the jaw. Such a method is helped by having a simple switching port at the end of the user's handle, for instance by means of a quarter-turn fit that can optionally be spring-loaded. Other similar quick-exchange attachment methods are also envisioned.

Using specific J-shaped cleaning device headpieces for left and right jaw allows for a closer fit. For an idealized fit, a mold can be manufactured from the user's teeth and the cleaning device head shaped accordingly.

The cleaning device's head, preferably in the essential J-shape that follows the user's half jaw, with a H-type cross section, can in one embodiment be made of one single piece of cleaning fluid compatible plastic or composite material, for instance molded or 3-D printed plastic.

It is also conceived that in another embodiment said cleaning device is made from a metallic core, such as for instance, but not limited to stainless steel or anodized aluminum or titanium which can easily sustain high pressure, while the surrounding area is made of a plastic that can be molded, 3-D printed, machined or otherwise generated.

Combined manufacturing techniques, such as molding, with additional drilling (including laser drilling) of cleaning nozzles is envisioned as advantageous in providing lowest cost devices while maintaining precision orifices for the cleaning fluid.

Preferably the headpiece or at least the more complex geometries of the headpiece as a whole is made from an injection molded likely fiber reinforced composite material, with the cleaning orifices themselves drilled using methods such as laser or mechanical drilling. The headpiece itself can be made from a plurality of pieces that are then attached and fastened to each other.

Figures in this disclosure depicting a letter J-shaped headpiece details also teach the adequate care in providing geometries that avoid undercuts for best manufacturing using injection molding, combined with nozzle drilling.

Prior art devices have not focused on keeping pressure constant across the geometry of the device. The water pressure within the cleaning device is preferably not too different between nozzles or orifices far from the water supply (posterior teeth applications) than for those closer to the water supply (anterior teeth application). One method is to have a substantially larger cross section channel run through the center of the device, e.g. through the bridge of the H-cross section than through each of the individual cleaning nozzle channels.

Another water distribution embodiment is to have an essentially ring-shaped supply line arrangement, so that each nozzle gets supplied by one part of a supply line with a short distance and another part of the line with a long distance to the water source.

In addition, it is envisioned that when the distribution of pressure within the device is known, that cleaning fluid orifices are drilled or in general manufactured such that through proper design of orifice diameter, depth and other geometry, the fluid flow is retained to an optimum distribution. Such an optimum distribution can mean enabling uniform flow and impact across the plurality of liquid orifices, or can mean enabling desired flow and flow ratio between different orifices of the headpiece. For instance, it can be desired to have higher pressure for those orifices applied to larger rear molars to dislodge debris and particles from deep within the gap between two large molars than the pressure required to affect cleaning of comparatively smaller teeth and smaller gaps between teeth.

These and other advantages of the disclosed subject matter, as well as additional novel features, will be apparent from the description provided herein. The intent of this summary is not to be a comprehensive description of the subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages included within this description be within the scope of the claims.

### BRIEF DESCRIPTION OF THE DRAWINGS

The features, nature, and advantages of the disclosed subject matter may become more apparent from the detailed description set forth below when taken in conjunction with the drawings in which like reference numerals indicate like features and wherein:

FIG. 1 depicts the overall assembly including a supply for pressurized cleaning fluid or water, a feed line to a handle, a handle with controls, a rigid feed line to a headpiece connector and a headpiece assembly, consisting of a letter J-shaped headpiece;

FIG. 2 is a depiction of a human set of jaws with the upper (maxillary) and the lower (mandibular) teeth;

FIG. 3 illustrates human jaws with J-shaped cleaning device head applied;

FIG. 4 depicts an essentially posterior view of a J-shaped cleaning device headpiece, with an essentially letter H-shaped cross section, including cleaning nozzles, flexures, cutouts for draining, a liquid feed line and connector;

FIG. 5 depicts an essentially anterior view of a J-shaped cleaning device headpiece, with an essentially letter H-shaped cross section, including cleaning nozzles, flexures, cutouts for draining, a liquid feed line and connector;

FIG. 6 depicts a horizontal cross-sectional view across the J-shaped cleaning device headpiece, showing liquid channels and threads or bores for tightening upper and lower parts of a cleaning headpiece to each other;

FIG. 7 depicts an internal vertical cross section through the letter J-shaped headpiece, showing horizontal supply channels and taken in a region where vertical supply channels extend through the lingual and facial region and supplying individual nozzles.

FIG. 8 depicts an internal vertical cross section through the letter J-shaped headpiece, taken near the feed line and showing distribution of cleaning liquid into channels for serving facial and lingual, maxillary and mandibular regions;

FIG. 9 shows an alternative geometry for a J-shaped headpiece, where drain openings are employed instead of cutouts;

FIG. 10 shows a J-shaped headpiece, equipped with a clamp holding a suction tube that facilitates draining of spent cleaning liquid;

FIG. 11 shows an example of a flexure arrangement with open arc flexures or bristles as part of the headpiece;

FIG. 12 shows a headpiece cross-section, inserted between a user's jaws, with the jaws not pressing down on the flexures;

FIG. 13 shows a headpiece cross-section, inserted between a user's jaws, with the jaws pressing down on the flexures;

FIG. 14 shows a handle of a cleaning device, with buttons enabling liquid flow, headpiece rotation and sonication;

FIG. 15 shows another embodiment of a J-shaped headpiece, with lingual and facial sections connected using compliant bridges;

FIG. 16 shows a top view of an embodiment of a J-shaped headpiece with lingual and facial sections connected using compliant bridges and with individual feed lines supplying each section, one of the feed lines being rigidly connected to the handle, the other compliantly connected to the handle;

FIG. 17 shows an example supply station, with a position for resting and cleaning the headpiece between uses;

FIG. 18 shows a supply option with a connection to a faucet;

FIG. 19 shows a liquid supply where pressure is applied manually;

FIG. 20 shows an embodiment where the cleaning headpiece arrangement consists of two letter J-shaped headpieces which are alternatively supplied with cleaning liquid;

FIG. 21A shows an embodiment where the cleaning headpiece arrangement consists of two foldable letter J-shaped headpieces which are inserted into the mouth in a folded geometry;

FIG. 21B shows the structure of FIG. 21A in an unfolded state for insertion into the user's mouth to form an overall letter U-shaped headpiece arrangement; and

FIG. 21C is an enlarged view of a portion of the pivot point of the structure of FIG. 21B.

### DETAILED DESCRIPTION

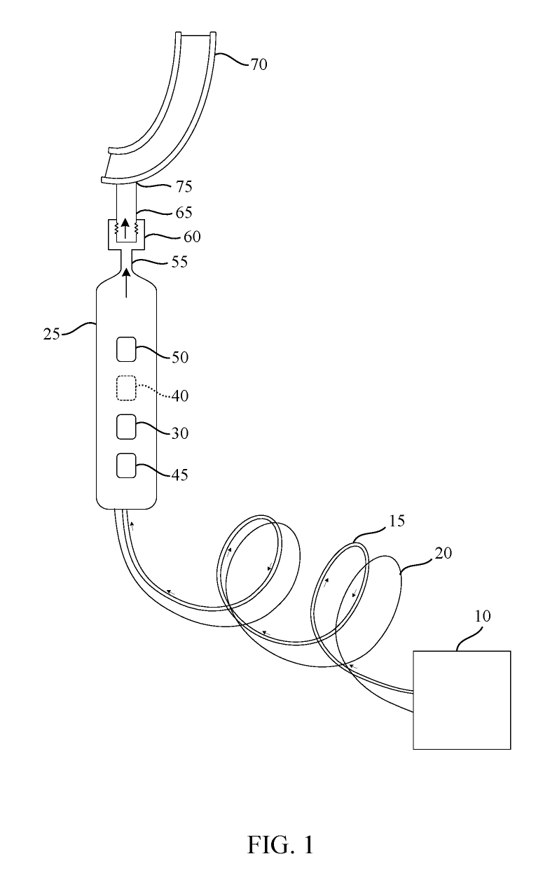

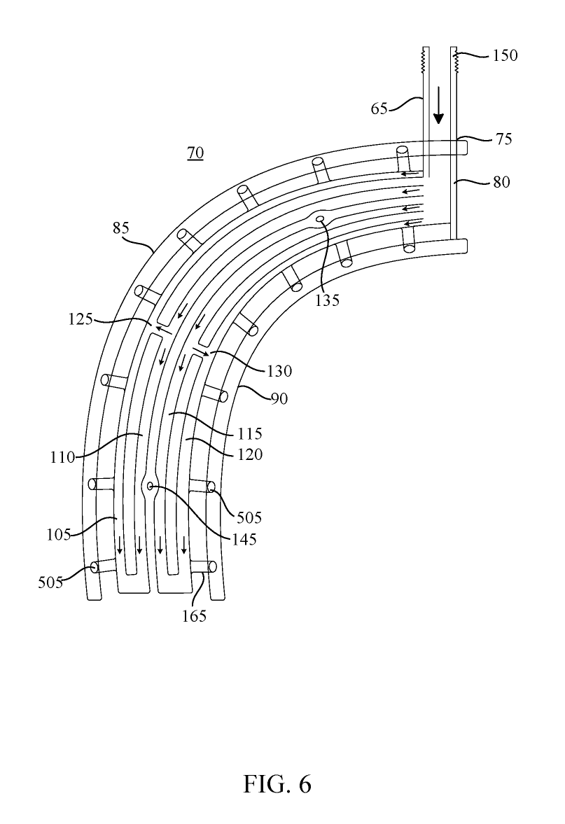

FIG. 1 gives and overview of the cleaning device 5. It shows the supply 10 for providing pressurized cleaning liquid to a headpiece 70 via a flexible feed line 15 and handle 25, and an optional flexible electrical connection line 20 to a control handle 25 which is needed if the control handle is not battery operated or sends wired control signals to the supply 10. The handle 25 is depicted with a flow enabling button 30, activated by a user's finger, an indicator light for liquid flow 35, an optional second flow enabling button 40, on the opposite site of said handle, for added shut-off safety, an optional sonication activation button 45 to add sonic or ultrasonic activity to the cleaning liquid or the headpiece 70. Additionally, an optional headpiece flip button 50 is depicted, which serves to flip the headpiece by 180 degrees for insertion into the other side of the jaws. The handle is depicted with a rigid supply line 55 for cleaning liquid from the handle to the easy-exchange headpiece connector 60. Headpiece main liquid feed line 65 is rigidly connected to the headpiece connector 60 and is an integral part of the headpiece 70. Beyond the entry port 75 for cleaning liquid into the headpiece 70, the cleaning liquid is distributed via a manifold 80 (shown in FIG. 6) into liquid supply or distribution channels within the headpiece 70 as described below. The headpiece consists of a facial region or segment 85 and a lingual region or segment 90, each containing a plurality of cleaning nozzles also described below.

Push-buttons on the handle are placed in ergonomically suitable positions. At least one push button 30 operates a normally closed valve or opener which enables the flow of water through the tubing and into the cleaning device head. This enables immediate control of the users to cause a shut-off of liquid flow to the mouth, should an excess amount of liquid be felt. Optionally and for redundancy, a second flow enabling push-button 40 can operate a second normally opened valve. Since any even temporary oversupply of cleaning liquid to the user's mouth is one of the main occurrences to avoid, such redundancy may be very desired or deemed necessary.

The easy-exchange headpiece connector 60 is very advantageous for providing replacement headpieces, to switch quickly between users or even to use a different headpiece between left and right portion of the jaws. Several simple attachment mechanisms, such as a thread or a ¼ turn screw or ¼ turn screw with spring loading or a snapping clamp are envisioned for the connection.

For use of both sides, several ways are envisioned: the first is that the device and handle are just rotated 180 degrees and inserted to the mouth and cover the other side of the jaw (left, then right or vice versa). It is also envisioned that instead, a J-shaped cleaning device head is exchanged from a left-side fitted to a right-side fitted cleaning device head. Said exchange is facilitated by using a simple attachment exchange mechanism, such as the ¼ turn screw or similar, as suggested. It is also envisioned that a mechanism be placed within the handle 25 which rotates the headpiece by 180 degrees when outside of the user's mouth and said mechanism is activated by an optional headpiece flip button 50 on the handle.

In addition, it is envisioned to add sonic energy to the device, by using an optional sonication activation button 45, which can be part of the handle 25 or of the main supply and control unit 10. Especially but not solely if the headpiece contains bristles in addition to dispense nozzles such added sonication can be useful to enhance the cleaning result. Sonication to augment dental cleaning can be implemented in several ways. Sonic or ultrasonic transducers that are in contact with water can generate micro-bubbles that support cleaning action. This can be done either at a liquid reservoir or supply 10 or as fluid passes through the handle 25, or by vibrating the headpiece 70 at sonic frequency. With headpiece 70 and handle 25 sufficiently rigidly connected, sonic energy can be translated from handle to headpiece and generate small but fast sweeping motions of the fluid jets that are directed towards the teeth via cleaning nozzles.

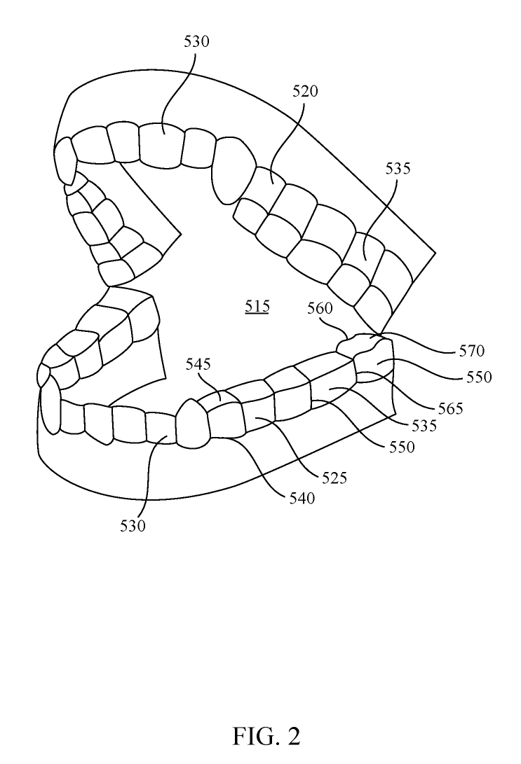

FIG. 2 shows a set of human jaws 515, with left and right, maxillary 520 and mandibular 525 anterior 530 and posterior 535 teeth, with neck and gum regions 540, crown regions 545, interdental gap regions 550 and with facial 555 or lingual 560 as well as mesial 565 and distal 570 tooth surfaces.

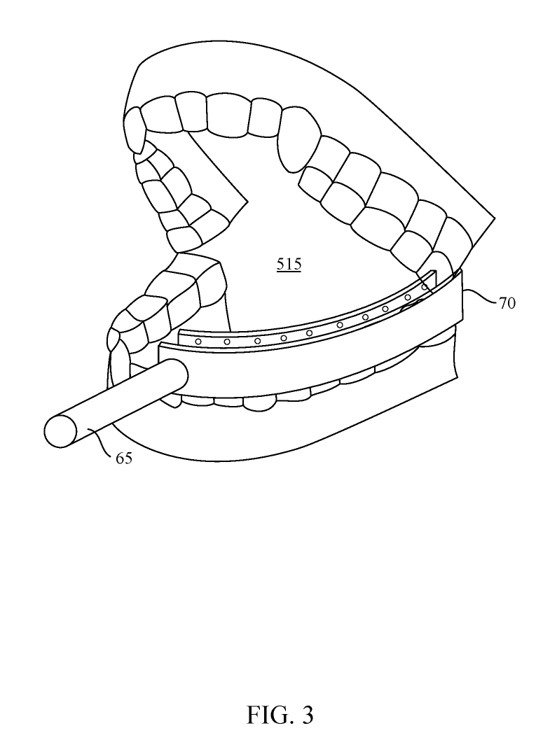

FIG. 3 shows a letter J-shaped cleaning device headpiece 70, with an H-shaped cross-section, placed within a set of human jaws 515. It is to be noted that the cleaning device headpiece 70 extends just beyond the centerline of the anterior teeth and just beyond the last posterior tooth. This assures that as the device cleaning head is flipped by 180 degrees for the second cleaning step, in summary all anterior and posterior teeth are overall properly addressed for cleaning. Said device concept is of course also applicable to the cleaning of animal teeth, with suitable cleaning device headpieces.

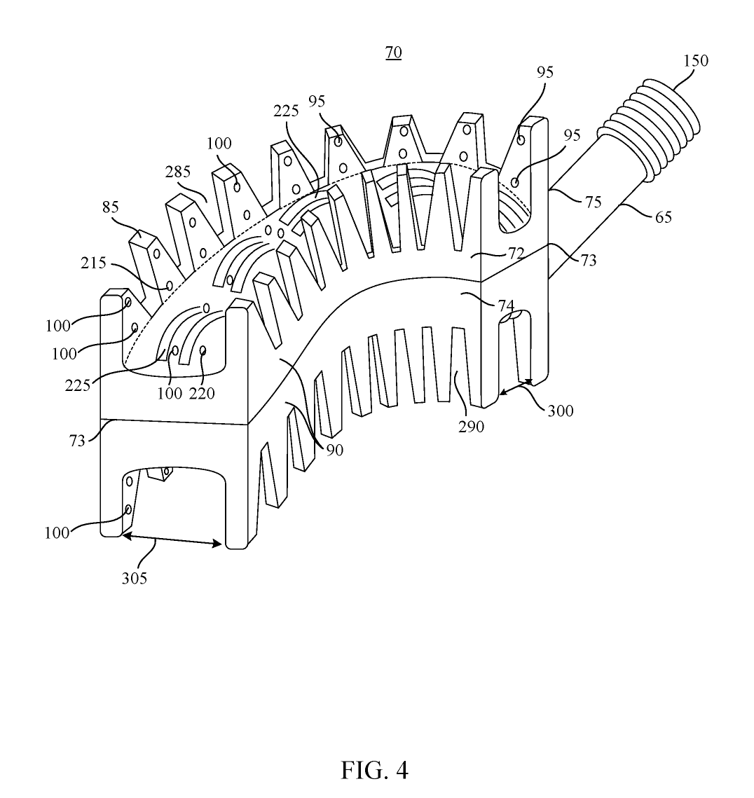

FIG. 4 shows a letter J-shaped cleaning headpiece 70. For manufacturing ease, especially in the case of injection molding and to enable the formation of internal liquid distribution channels at low cost, it is envisioned to have said headpiece 70 be comprised of an upper segment 72, a lower segment 74 and a seam region 73 where upper and lower segment are joined together. Joining of said segments can be added by fasteners such as rivets, threads or bolts or adhesives, sealing of said seam region can be aided using adhesives such as glue or using a gasket sheet to be compressed using said fasteners.

Cleaning liquid enters the headpiece 70 through a main liquid feed line 65 at entry port 75. The liquid is distributed into channels (see FIGS. 6-8) and distributed horizontally along the headpiece and then vertically to a plurality of cleaning nozzles, from the anterior region cleaning nozzles 95 to the posterior region cleaning nozzles 100. Cleaning nozzles 210 can be positioned to address tooth neck and gum region and interdental gap regions, cleaning nozzles 215 can be positioned to address lower tooth crown region and interdental gap region, while cleaning nozzles 220 can be positioned to address tooth crown region and interdental gap regions. Nozzles are implemented within the facial segment 85 of the headpiece 70 for cleaning from the facial side, while other nozzles are implemented within the lingual segment 90 of the headpiece 70 for cleaning from the lingual side. For optimized draining of dispensed liquid after impinging, it is advantageous to provide cutouts 285, 290 within the headpiece 70, on the facial side or on the lingual side or on both sides. For good sustained mechanical impingement of the fluid from the nozzles onto teeth and gum areas, it is preferable for cutouts 285, 290 to extend down a good amount, for instance more than 50% from the top of the wall portion height to the base of the headpiece.

The cross-section 295 of the headpiece 70 represents an approximate H-shape, where it is to be noted that the lateral gap in the anterior region 300 and the lateral gap in the posterior region 305 do not need to be equal. The lateral gap in the anterior region, when designed large enough to leave space between anterior teeth and the facial and lingual sidewalls of the headpiece is readily seen to facilitate movement of the whole headpiece towards the anterior and posterior, so that the cleaning nozzles can be laterally placed in desired positions during the cleaning. Preferably the distance between cleaning nozzles is smaller than the gap in the anterior region 300, so that in principle every position of teeth and gums can be directly accessed by a cleaning nozzle.

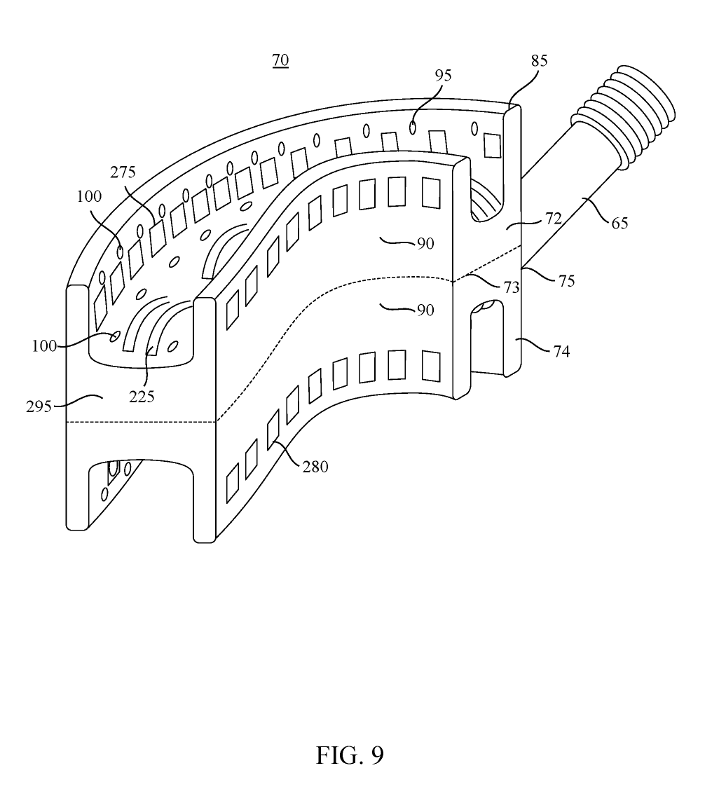

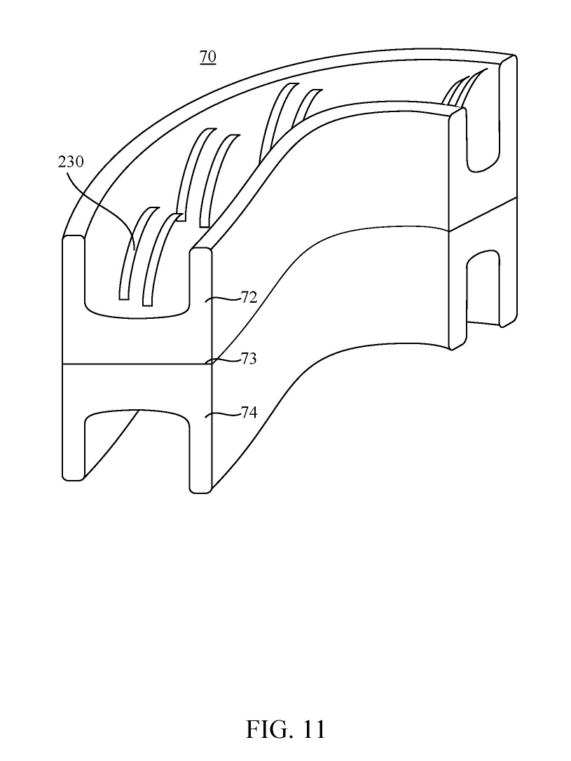

Vertical control of the cleaning nozzle height with respect to the user's teeth and gum is facilitated by a set of suitably compliant flexures 225. As the user's teeth compress the flexures, good control of the cleaning nozzle height with respect to teeth and gum height is readily exercised. The flexure 225 depicted in FIG. 4 is a closed arc flexure, which has essentially two connections to the body of the headpiece 70. Several embodiments of flexures are envisioned, all with the goal of giving the user good and compliant control for positioning the cleaning nozzles that are integrated into the substantially rigid headpiece 70 with respect to desired tooth and gum regions; FIGS. 4 and 9 show closed arc flexures, while FIGS. 11, 12 and 13 show open arc flexures, to show just two examples. Open arced flexures can be devised as only anchored on one side and thus having more the shapes of bristles, albeit bristles whose tips do not necessarily point towards teeth. Said single side anchored flexures can be thought of as cantilevers. Having such cantilevered flexures enables in general a larger vertical range for the headpiece for the same cantilever (or flexure) length when compared with a closed arc flexure.

Overall, the design features of headpiece 70, with flexures, draining holes or cutouts, as well as with rigid coupling to the handle 25 and sufficient gap between the walls of the headpiece and teeth and gums enable significant cleaning advantages. The user can precisely and conveniently position the cleaning nozzles to address desired positions, while at the same time, the relative movability of said nozzles with respect to teeth and gums allows a headpiece design with an optimized number of nozzles, low enough to prevent flooding of the device and mouth which would render nozzles ineffective, yet high enough to enable drastic time savings for teeth and gum cleaning, due to multiple parallel action.

It should be noted that for an optimized injection molding process for manufacturing said cleaning headpiece, the components of said cleaning headpiece preferably have all inner and outer sidewalls with angles opened somewhat towards the direction of removal of the injection molding tools after the injection molding process. This holds for outer sidewalls, as well as for channels, both horizontal as well as essentially vertical supply channels within the headpiece. Such angles are not necessarily depicted in the drawings across this disclosure but are considered covered as part of this disclosure and their necessity is readily understood by someone with knowledge in the art of injection molding. In addition, it should be noted that all edges of said headpiece 70 are designed with radii or bevels to achieve maximum comfort for the user. Also, for human jaws, the height of the H-shaped cross-section in the anterior region of the headpiece is preferably designed to be taller than in the posterior region, thereby conforming to normal dental anatomy.

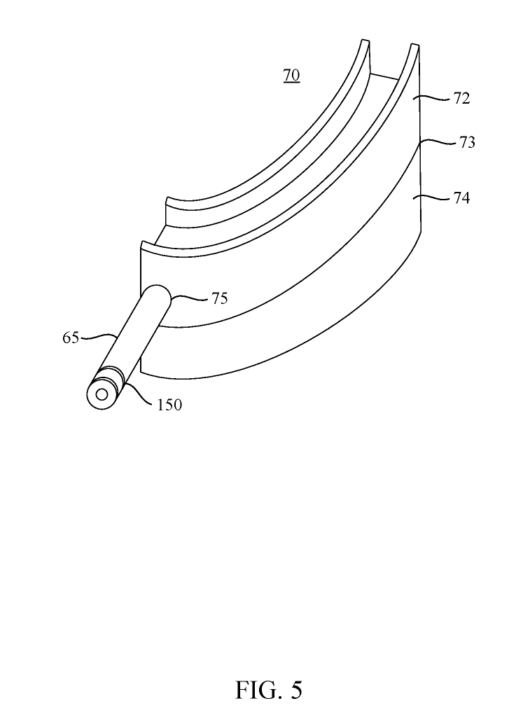

FIG. 5 represents the headpiece 70 from FIG. 4 in an essentially anterior view. The liquid carrying channel in the feed line 65, entering the headpiece main body at the entry port 75 is depicted. The thread or flange 150 for quick exchange of the headpiece is also shown.

FIG. 6 represents a horizontal cross-section through the headpiece 70, taken close to the center height of the headpiece, close to the potential seam region 73. Cleaning liquid enters the headpiece 70 via the main liquid feed line 65 at port 75 and is distributed via liquid distribution manifold 80 into the horizontal distribution channels, here depicted as outer horizontal facial liquid distribution channel 105, inner horizontal facial liquid distribution channel 110, outer horizontal lingual liquid distribution channel 115 and inner horizontal lingual liquid distribution channel 120. From the horizontal distribution channels, the liquid gets further distributed into the individual vertical distribution channels 505 via a connection 165 and to the individual nozzles. Horizontal distribution channels may contain pressure and flow balancing orifices or connections, on the facial side 125 and on the lingual side 130. The channel geometry depicted is an example of a geometry that is suited for desired pressure and flow strength and uniformity tuning, as well as for manufacturability. The distribution channels shown here have essentially a loop geometry. This is to reduce the effect of loss of flow going from anterior to posterior teeth that one may otherwise see. Alternatively, the connections between anterior vertical channels to the horizontal channels can be laid out smaller than the between posterior vertical channels to the horizontal channels to also mitigate the effect of pressure and flow loss. Also depicted in the figure are threads or bores 135 for connecting the upper section of the headpiece to the lower section of the headpiece, as well as an example screw, rivet or dowel pin 145 for securing this connection.

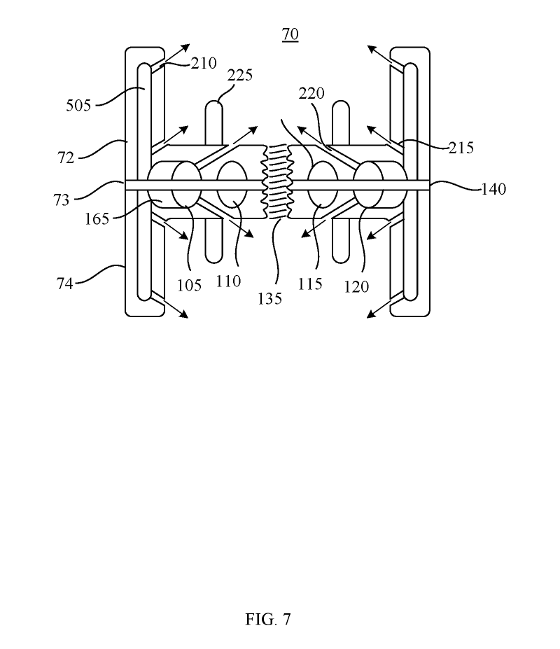

FIG. 7 shows a cross-section of the headpiece 70 in the region where vertical connection channels 505 connect the liquid to the individual nozzles 210 (gum, neck and gap region), 215 (lower crown and gap region) and 220 (crown and gap region). Connecting channels 165 from the horizontal channels 105, 110, 115, 120, lead to the vertical channels and/or directly to individual cleaning nozzles. A thread or bore 135 to connect upper section 72 with lower section 74 of the headpiece 70. In this view, the connecting region 73 between upper and lower section of the headpiece is shown to be comprised of a gasket or finite thickness adhesive or glue film or glue layer 140.

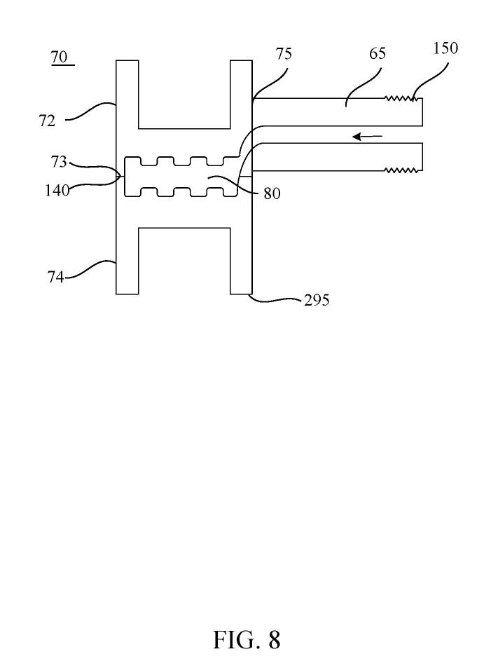

FIG. 8 shows a cross-section of the headpiece 70 in the region where the main liquid feed line 65 enters the headpiece at entry port 75. Within the cross-section 295 a liquid distribution manifold 80 is shown which distributes the liquid into facial and lingual liquid channels within the headpiece. This cross-section also teaches how the headpiece can be manufactured from an upper section 72 and a lower section 74 which are joined and sealed in a seam region 73. Said seam region 73 can optionally contain a gasket sheet or an adhesive or glue layer 140. Angles used should be less than 90 degrees if the use of injection molding as manufacturing technique is desired.

FIG. 9 shows a variation of a cleaning headpiece where the cutouts 285 shown in FIG. 5 are replaced by draining holes 275 and 280, in the facial and lingual sections, respectively, of the headpiece 70. While the use of drainage holes may require subtractive machining compared to injection molding for cutouts, the structure may lend more rigidity to the headpiece 70. Said draining holes, but also the drainage cutouts 285 and 290 as depicted in FIG. 4, preferably towards the facial and specifically labial part of the cleaning device help with quickly draining the cleaning fluid from the mouth to avoid excess fluid in the mouth. The density, size and number of said draining holes or cutouts can be optimized for good drainage as well as suitable dwell time of the cleaning solution close to the teeth where needed. For instance, a setup where only water is used may require less or no dwell time, thereby benefitting from more and/or larger holes, whereas a setup with significant cleaning fluid action may benefit from extended dwell time of said cleaning fluid in the vicinity of the teeth and gums to be cleaned. For best drainage, the perforations can be maximized while retaining mechanical stability of the cleaning device head. The drainage holes or in general the drainage geometry should be chosen large enough to enable draining of material and debris that is loosened from teeth, gums and crevices by the cleaning action of the nozzles and the cleaning fluid.

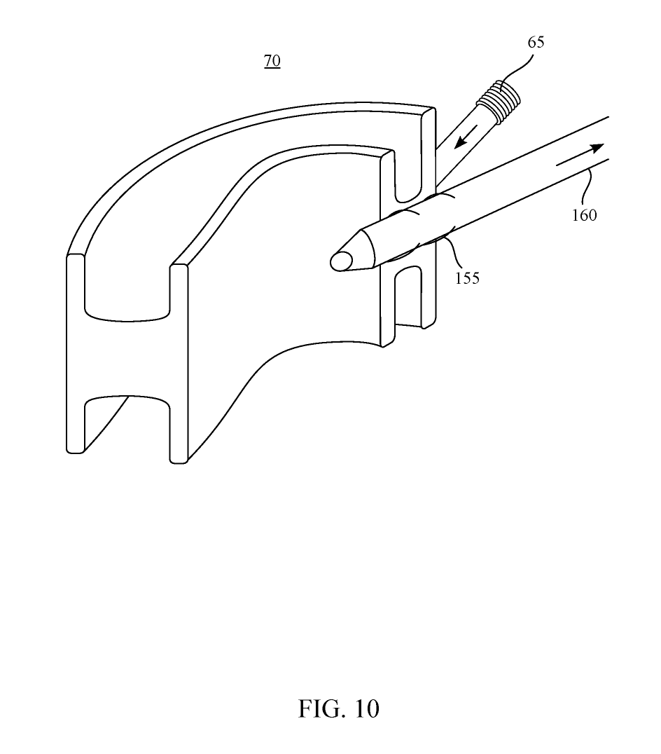

FIG. 10 shows an optional embodiment of the cleaning headpiece 70 with a clamp or holder 155 attached to hold an optional suction line 160 for dispensed cleaning liquid. Such addition of a suction line is seen mainly as advantageous when the cleaning is being carried out by caregivers, for instance to serve elderly or disabled people. Otherwise it is expected that the draining of dispensed cleaning liquid is most readily achieved by the user through the help of gravity and using the device in immediate proximity to a sink.

FIG. 11 shows a rigid headpiece 70 with compliant open arc flexures or bristles 230. Such open arc flexures can be compressed simply by the user pressing down on the headpiece 70 and thus direct cleaning nozzles along desired heights to address gums, teeth necks, crowns or interdental gaps for cleaning.

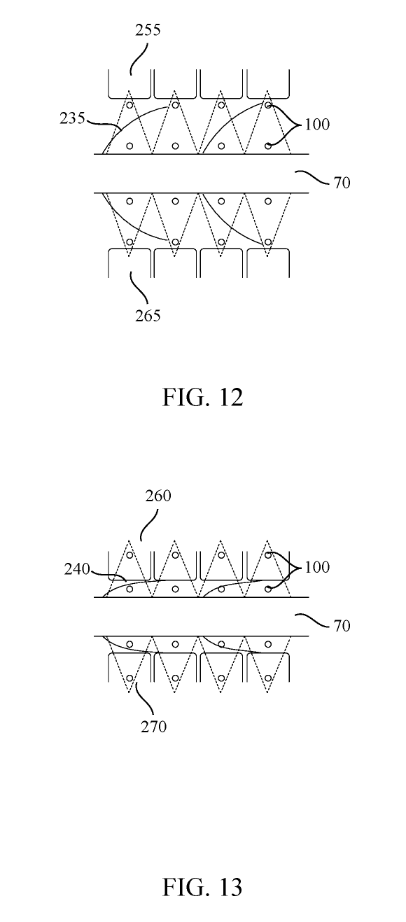

FIG. 12 and FIG. 13 show, with the example of open arced flexures or bristles, how the user, with relaxed maxillary and mandibular jaws 255 and 265, respectively, or compressed maxillary or mandibular jaws 260 and 270, respectively, can manipulate the position of the nozzles of the headpiece 70 with respect to the heights of nozzles to address gums, teeth necks, crowns or interdental gaps by having said flexures relaxed or open 245 or compressed or clamped 250 depending on the bite force exerted by the user's jaws against the headpiece 70.

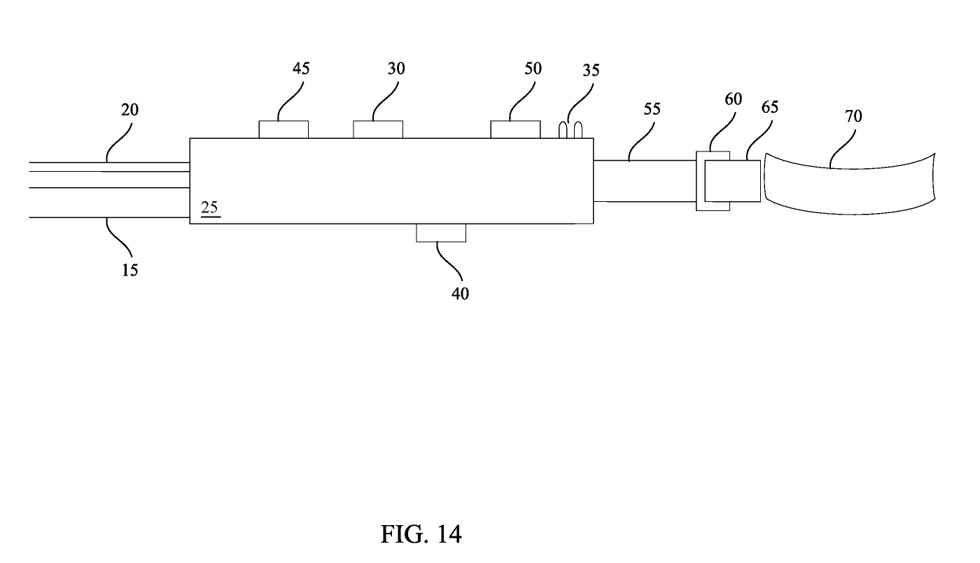

FIG. 14 shows how a handle 25 to control said cleaning headpiece 70 can be designed. Indicator lights 35, preferably LED's, can be used to inform the user of the status of the device. It is seen as advantageous to have a push-button 30 on the handle enable the pressurized liquid flow to the headpiece. If desired, a secondary, independent button 40, can be implemented on the same handle to insure immediate turn-off of pressurized water supply to the headpiece when released. If the device is to have sonication to enhance the cleaning effect, an additional push-button 45 may enable this. Additionally, a push-button 50 may serve to provide convenient rotation of the headpiece 70 by 180 degrees without rotating the handle. This way, the user can conveniently retain their hand position when cleaning the other half of his or her jaws after rotating the headpiece.

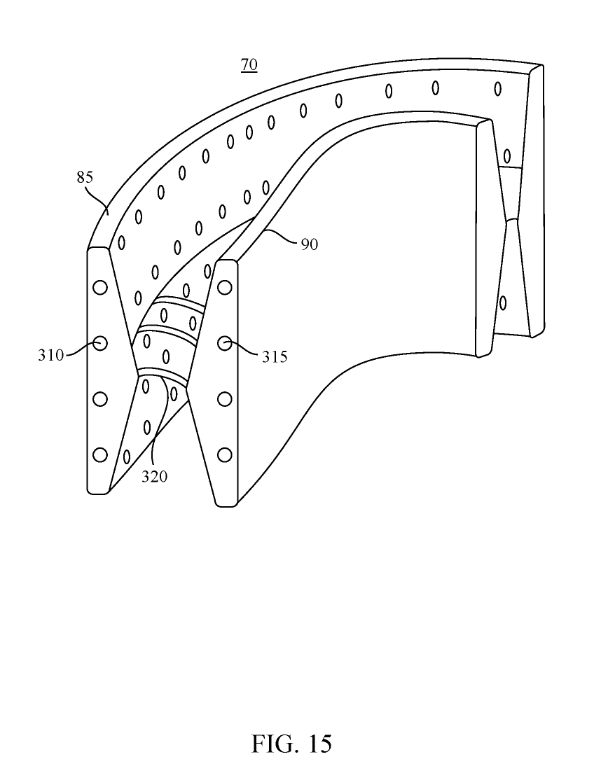

FIG. 15 shows an embodiment of a cleaning headpiece which is essentially divided into a facial segment 85 and a lingual segment 90, connected via flexible bridges 320. Horizontal distribution channels 310 and 315 run within each segment, leaving substantial space for draining between the bridges 320 through the center. Facial segment 85 and lingual segment 90 can move against each other to accommodate difference between upper and lower jaw of the user.

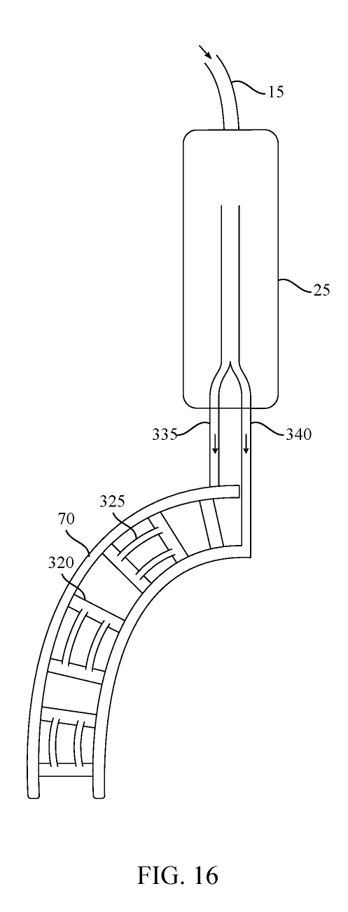

FIG. 16 shows the embodiment introduced in FIG. 15, but from a top view. As in previously described embodiments, flexures 325 can be employed to conveniently and precisely position the headpiece 70 and its nozzles with respect to teeth and gums. It is to be noted that in order to enable effective movement of facial and lingual segment of the headpiece against each other, it is advantageous to have two feed lines 335 and 340 to facial and lingual segment, respectively, wherein one of the lines is connected rigidly to the handle, whereas the other is connected sufficiently compliant to enable flexible movement of facial and lingual cleaning headpiece segment against each other. The pressurized liquid flow from the supply is preferably distributed to each segment within the handle 25.

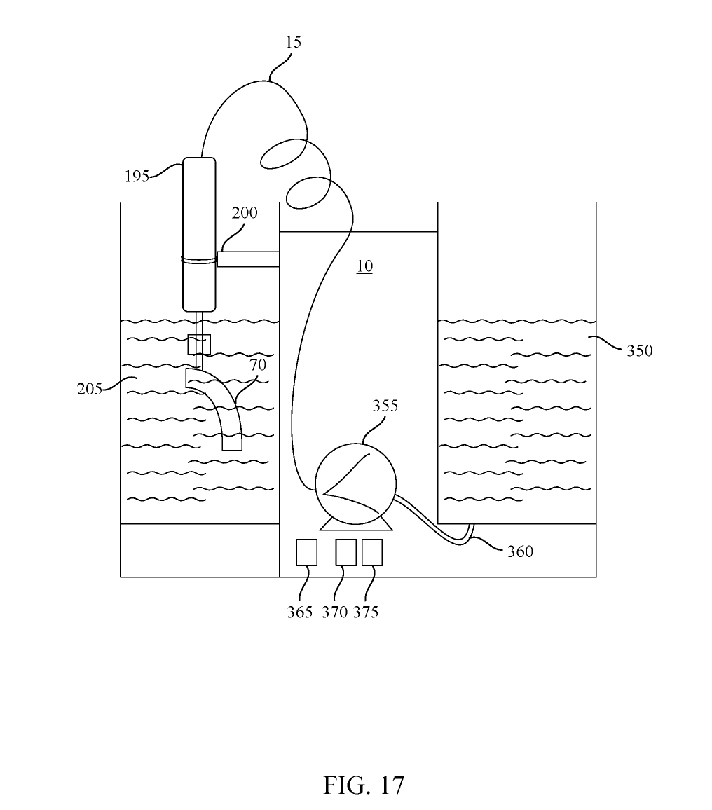

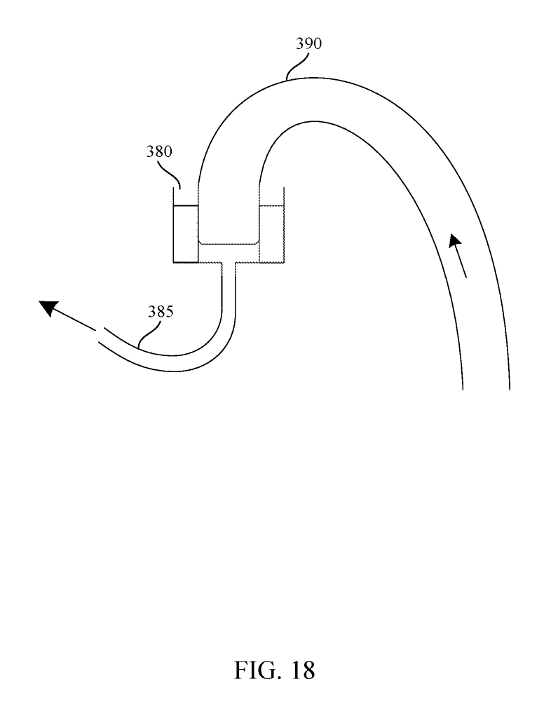

FIG. 17 depicts the concept of a main supply station 10 for the cleaning device, showing the cleaning device in a holder for resting and rinsing 195, with the handle clamped in place using a clamp 200, which optionally enables liquid flow through the headpiece 70 while in the resting and rinsing position and tank 205. The supply pump 355 is also depicted, together with a liquid supply tank or reservoir 350, which optionally can be removed or optionally can be automatically filled with a liquid. Said supply tank supplies the pressure pump via feed line 360. Control button 365 turns on the pump, button or dial 370 controls the pump function and pressure or flow, while control dial 375 determines cleaning cycles for the device. Alternative controller setups or layouts, including menu driven options, are also envisioned.

FIG. 18 depicts a setup to use liquid directly from a faucet 390. The fluid line 385 is connected to said faucet by a sealable faucet connection 380 and can fill the reservoir 350, depicted in FIG. 17, or directly provide pressurized liquid to the handle 25, depicted in FIG. 1.

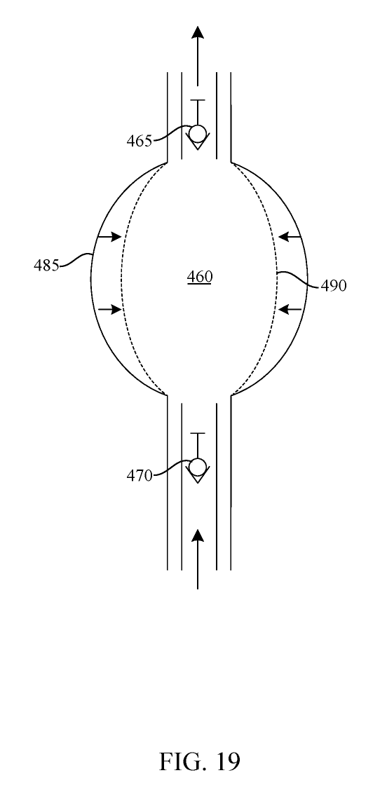

FIG. 19 shows a simple arrangement where instead of a pump 355, as depicted in FIG. 17, the pressurizing of the liquid is achieved via a hand-compressible fluid reservoir 460, which can serve as a handle as well, with check valves 470, 465 from the fluid supply 10 and to the cleaning device headpiece 70. Outlines 485 and 490 illustrate the manually compressible reservoir 460 in a relaxed and in a compressed position, respectively. Said check valves operate in the following manner: during compression of the vessel, the check valve to the cleaning device headpiece 465 is open and the check valve to the supply tubing line or fill port 470 is closed. During expansion (relaxation) of the compressible vessel, the check valve to the cleaning device headpiece 465 is closed and the check valve to the filling line or filling port 470 is open. Instead of check valves which operate upon pressurization, it is also possible to add ergonomically placed switch buttons to the compression handle.

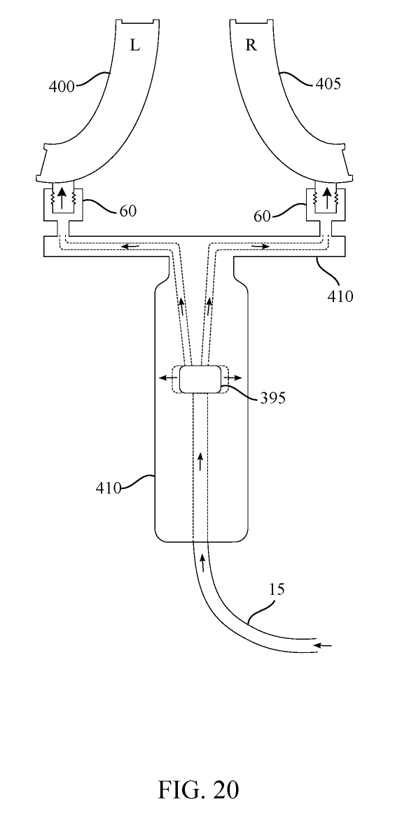

FIG. 20 shows opposing letter J-shaped cleaning device headpieces 400 and 405, which get used and inserted sequentially in the mouth. For this arrangement, a 3-way Left-Off-Right toggle switch 395 is employed as part of a handle 410 which is supplied with one liquid feed line 15 and alternatingly supplies dual feed lines to the headpieces. 400 and 405, which are each attached by an easy-exchange headpiece connector 60.

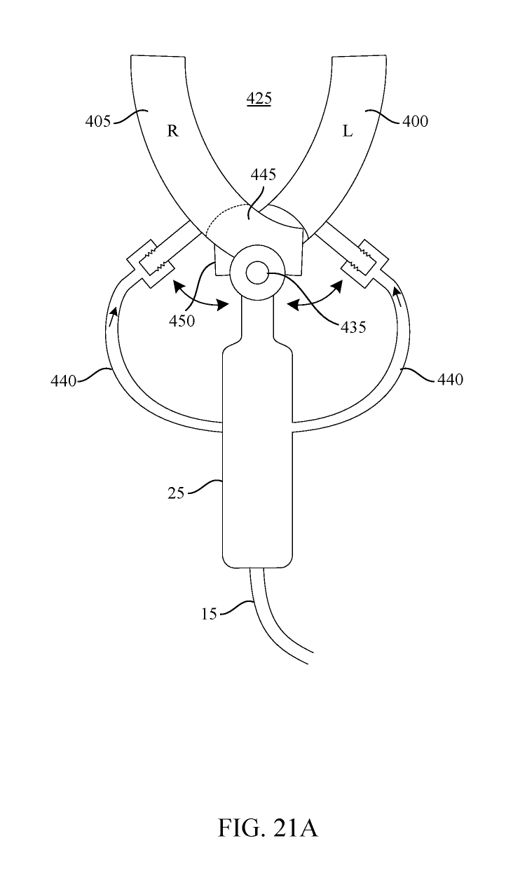

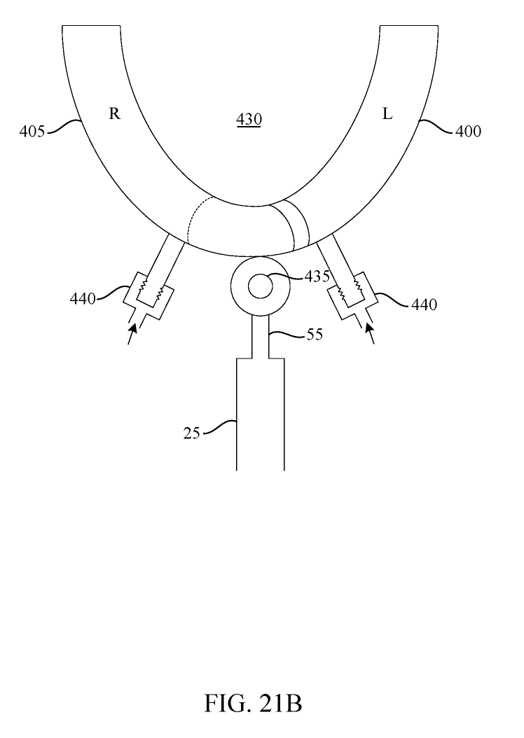

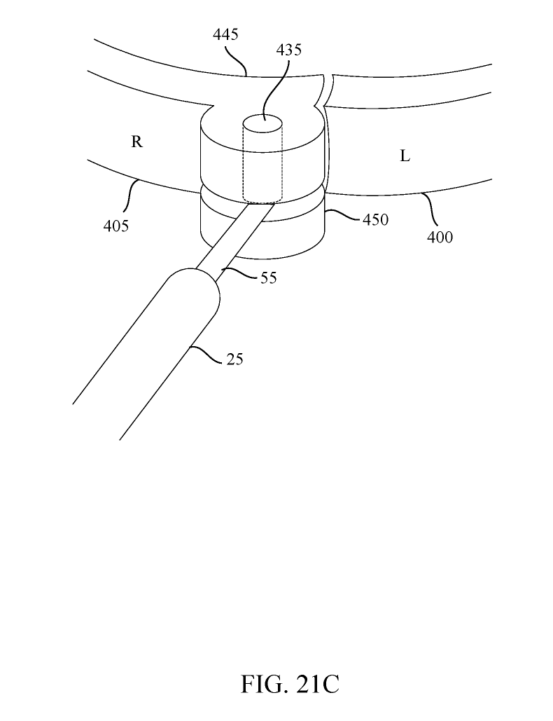

FIG. 21 shows a cleaning headpiece arrangement with foldable and un-foldable double J left and right headpieces 400 and 405, respectively. The arrangement serves to more easily induce and extract the cleaning device headpieces into the mouth and from the mouth, respectively. During the cleaning, the double J arrangement is widened up to form essentially a U-shaped cleaning device headpiece which then addresses both the left and the right part of the jaw, either at the same time or sequentially, if a 3-way toggle switch 395 akin to the embodiment depicted in FIG. 20 is implemented.

FIG. 21A shows the device folded together 425 for insertion into or retraction from the mouth. It shows the individual fluid feed lines 440 to each headpiece. Also shown is a pivot point 435 around which the two headpieces 400 and 405 are rotated during the folding and unfolding. The device is controlled by a handle 25 and fed pressurized cleaning liquid through a feed line 15. In the anterior region of the jaw, headpiece 400 covers cleaning of mandibular teeth and is thus reduced in height in region 450, whereas headpiece 405 covers cleaning of maxillary teeth and is thus reduced in height in region 445. This complementary reduction in height in the anterior region allows for the two headpieces 400 and 405 to be pivoted and folded towards each other for insertion into the user's mouth.

FIG. 21B shows the device in the unfolded shape which is used during the cleaning cycle. Left and right headpiece 400 and 405, respectively, form an essentially U-shaped combined headpiece 430 to address all teeth in the user's jaws.

It is advantageous to have a pivoting point outside of the mouth, in front of the anterior teeth.

FIG. 21C shows a detail how the two J-shaped headpieces 400 and 405 can overlap for best functionality. For instance, for the central anterior teeth it can be advantageous that one half (e.g. the right J) addresses the cleaning of the maxillary anterior teeth, position 445, while the other half (e.g. the left J) addresses the cleaning of the mandibular anterior teeth, position 450. In the anterior region of the jaw, headpiece 400 covers cleaning of mandibular teeth and is thus reduced in height in region 450, whereas headpiece 405 covers cleaning of maxillary teeth and is thus reduced in height in region 445. This complementary reduction in height in the anterior region allows for the two headpieces 400 and 405 to be pivoted and folded towards each other for insertion into the user's mouth.

The folding and unfolding of the arrangement is accomplished preferably by a simple push-button or switch-button operation on the cleaning device handle. Preferably a spring-loaded design is implemented which, when the push-button or switch-button is not engaged, relaxes the two J-shaped cleaning device heads into essentially a U-shaped cleaning device headpiece. For that, preferably the single tube required to bring water to the device is split into two lines within or close to the handle 25, to allow for this flexible arrangement. To a certain extent, such an arrangement can also be utilized to adapt to jaws of different widths, either by having the push button partially engaged to establish different opening angles, or by providing adjustable end positions of the two J-shaped cleaning devices. The arrangement benefits, in terms of simplicity, from having separate fluid feed lines for the left and right J-shaped cleaning device heads. This way, the feed lines can be more readily separated physically from the pivot point.

In much the same way that fluid can be guided to the teeth it is also envisioned that light, e.g. by means of light guiding fibers can be guided towards the teeth, with the exception that instead of a water pressure provider such a pump, there needs to be at least one central remote light source which is guided through the fiber. Alternatively, an array of small local LED's as part of the cleaning device head can be used, so that instead of a light fiber, electrical connection is made through properly encased wires. A combination of water and light is also possible.

For all of the above, the geometrical aspects are still viable, including providing a foldable insertion mechanism into the user's mouth.

It is to be noted that while all descriptions allude to a user cleaning their own teeth and gums, it is equally applicable to a caregiver or parent for cleaning teeth and gums of for instance a patient or a child.

The following clauses describe aspects of various examples of the technology disclosed.

1. A device for use in cleaning teeth and gums comprising: a headpiece having a liquid entry port, the headpiece having an H cross-sectional shape, the headpiece comprising:
an upper segment and a lower segment, the upper and lower segments having adjacent base portions and outwardly extending wall portions defining respective upper and lower channels, the upper and lower channels sized for receipt of sections of upper and lower teeth and gums of a user; and
cleaning nozzles fluidly coupled to the fluid entry port opening into the upper and lower channels capable of dispensing a liquid against sections of upper and lower teeth and gums of the user; and
resilient flexures extending from the base portions of the upper and lower segments into the upper and lower channels, the flexures capable of allowing a user to control the position of the user's teeth and gums relatively to the cleaning nozzles.

2. The cleaning device according to clause 1 wherein the headpiece further comprises drain openings formed in at least one of the wall portions of each of the upper and lower segments to facilitate draining of dispensed liquid from said headpiece.

3. The cleaning device according to clause 2, wherein the drain openings are created by cutouts in the wall portions, the wall portion having heights with the cutouts extending along at least 50% of the heights.

4. The cleaning device according to clause 2, wherein the drain openings are created by perforations in the wall portions.

5. The cleaning device according to any of clauses 1-4, wherein the cleaning nozzles are positioned to simultaneously direct liquid towards the upper and lower row of teeth and gums.

6. The cleaning device according to any of clauses 1-5, wherein said resilient flexures comprise closed arc members.

7. The cleaning device according to any of clauses 1-5, wherein said resilient flexures comprise at least one of open members and bristle members.

8. The cleaning device in any of clauses 1-7, wherein said headpiece is a J-shaped headpiece sized to accommodate sections of upper and lower teeth and gums of a user along at least half the user's jaw.

9. The cleaning device according to any of clauses 1-8, wherein the base portions comprise flexible members such as to permit relative flexing of the upper and lower segments to change the angle of the wall portions to accommodate upper and lower teeth of the user.

10. The cleaning device according to clause 9, wherein the upper and lower segments each have said liquid entry port to accommodate the relative flexing of the upper and lower segments.

11. The cleaning device according to any of clauses 1-10, further comprising a handle extending from the headpiece, the handle comprising a supply line for passage of a cleaning liquid to the liquid entry port.

12. The cleaning device according to clause 11, wherein said handle contains a sonication actuator element to add sonication to the flow of liquid towards the liquid entry port.

13. The cleaning device according to any of clauses 1-12, wherein said headpiece comprises first and second J-shaped headpieces pivotally connected at a pivot point, wherein said first and second headpieces can be folded in around said pivot point for insertion into the mouth and unfolded after insertion into the mouth two permit full coverage of the jaws of the user for simultaneous cleaning.

14. The cleaning device according to any of clauses 1-13, wherein said headpiece comprises bristles extending into the channels to be engageable with teeth and gums of the user.

15. A device for use in cleaning teeth and gums comprising:
a headpiece having a liquid entry port, the headpiece having an H cross-sectional shape, the headpiece comprising:
an upper segment and a lower segment, the upper and lower segments having adjacent base portions and outwardly extending wall portions defining respective upper and lower channels, the upper and lower channels sized for receipt of sections of upper and lower teeth and gums of a user;
cleaning nozzles fluidly coupled to the fluid entry port opening into the upper and lower channels capable of dispensing a liquid against sections of upper and lower teeth and gums of the user; and
drain openings formed in at least one of the wall portions of each of the upper and lower segments to facilitate draining of dispensed liquid from said headpiece.

16. The cleaning device according to clause 15, further comprising:
resilient flexures extending from the base portions of the upper and lower segments into the upper and lower channels, the flexures capable of allowing a user to control the position of the user's teeth and gums relatively to the cleaning nozzles;
a handle extending from the headpiece, the handle comprising a supply line for passage of a cleaning liquid to the liquid entry port;
said handle contains a sonication actuator element to add sonication to the flow of liquid towards the liquid entry port; and wherein:
said headpiece comprises a J-shaped headpiece sized to accommodate sections of upper and lower teeth and gums of a user along at least half the user's jaw.

17. The cleaning device according to clause 16, wherein said headpiece comprises first and second of said J-shaped headpieces pivotally connected at a pivot point, wherein said first and second headpieces can be folded in around said pivot point for insertion into the mouth and unfolded after insertion into the mouth two permit full coverage of the jaws of the user for simultaneous cleaning.

18. The cleaning device according to clause 1, wherein said headpiece arrangement comprises first and second of said headpieces,
wherein said headpieces can be alternatingly supplied with pressurized cleaning liquid, wherein said partial headpieces are formed essentially each in mirrored J-shape, each allowing covering approximately at least half the user's jaw,
wherein said headpieces are arranged such that the first headpiece can act as an active headpiece when inserted in the user's mouth, whereas the second headpiece can act as a passive headpiece outside the user's mouth.

19. The cleaning device according to clause 1, further comprising a liquid supply coupleable to the liquid entry port having a cleaning position for said headpiece and wherein before or after use the liquid supply can circulate water or cleaning fluid through the headpiece for flushing purposes.

20. A method for cleaning teeth and gums using a cleaning headpiece which addresses a plurality of teeth of a user's jaw simultaneously, wherein said headpiece is rigidly connected to a handle, said headpiece comprising a plurality of fluid cleaning nozzles, resilient flexures, fluid draining capability and a geometry with sufficient gaps between the cleaning headpiece and the user's jaws and wherein the user moves the headpiece's cleaning nozzles relatively up and down with respect to their teeth height by pressing down on flexures and wherein the user moves the headpiece in mesial and distal directions of their teeth by controlling the handle position.

What is claimed is:

1. A device for use in cleaning teeth and gums comprising:
a headpiece having a liquid entry port, the headpiece having an H cross-sectional shape, the headpiece comprising:
an upper segment and a lower segment, the upper and lower segments having adjacent base portions and outwardly extending wall portions defining respective upper and lower channels, the upper and lower channels sized for receipt of sections of upper and lower teeth and gums of a user; and
cleaning nozzles fluidly coupled to the fluid entry port opening into the upper and lower channels capable of dispensing a liquid against sections of upper and lower teeth and gums of the user; and
resilient flexures extending from the base portions of the upper and lower segments into the upper and lower channels, the flexures capable of allowing a user to control the position of the user's teeth and gums relatively to the cleaning nozzles.

2. The cleaning device according to claim 1 wherein the headpiece further comprises drain openings formed in at least one of the wall portions of each of the upper and lower segments to facilitate draining of dispensed liquid from said headpiece.

3. The cleaning device according to claim 2, wherein the drain openings are created by cutouts in the wall portions, the wall portion having heights with the cutouts extending along at least 50% of the heights.

4. The cleaning device according to claim 2, wherein the drain openings are created by perforations in the wall portions.

5. The cleaning device according to claim 1, wherein the cleaning nozzles are positioned to simultaneously direct liquid towards the upper and lower row of teeth and gums.

6. The cleaning device according to claim 1, wherein said resilient flexures comprise closed arc members.

7. The cleaning device according to claim 1, wherein said resilient flexures comprise at least one of open members and bristle members.

8. The cleaning device in claim 1, wherein said headpiece is a J-shaped headpiece sized to accommodate sections of upper and lower teeth and gums of a user along at least half the user's jaw.

9. The cleaning device according to claim 1, wherein the base portions comprise flexible members such as to permit relative flexing of the upper and lower segments to change the angle of the wall portions to accommodate upper and lower teeth of the user.

10. The cleaning device according to claim 9, wherein the upper and lower segments each have said liquid entry port to accommodate the relative flexing of the upper and lower segments.

11. The cleaning device according to claim 1, further comprising a handle extending from the headpiece, the handle comprising a supply line for passage of a cleaning liquid to the liquid entry port.

12. The cleaning device according to claim 11, wherein said handle contains a sonication actuator element to add sonication to the flow of liquid towards the liquid entry port.

13. The cleaning device according to claim 1, wherein said headpiece comprises first and second J-shaped headpieces pivotally connected at a pivot point, wherein said first and second headpieces can be folded in around said pivot point for insertion into the mouth and unfolded after insertion into the mouth two permit full coverage of the jaws of the user for simultaneous cleaning.

14. The cleaning device according to claim 1, wherein said headpiece comprises bristles extending into the channels to be engageable with teeth and gums of the user.

15. A device for use in cleaning teeth and gums comprising:
a headpiece having a liquid entry port, the headpiece having an H cross-sectional shape, the headpiece comprising:
an upper segment and a lower segment, the upper and lower segments having adjacent base portions and outwardly extending wall portions defining respective upper and lower channels, the upper and lower channels sized for receipt of sections of upper and lower teeth and gums of a user;
cleaning nozzles fluidly coupled to the fluid entry port opening into the upper and lower channels capable of dispensing a liquid against sections of upper and lower teeth and gums of the user; and
drain openings formed in at least one of the wall portions of each of the upper and lower segments to facilitate draining of dispensed liquid from said headpiece.

16. The cleaning device according to claim 15, further comprising:
resilient flexures extending from the base portions of the upper and lower segments into the upper and lower channels, the flexures capable of allowing a user to control the position of the user's teeth and gums relatively to the cleaning nozzles;
a handle extending from the headpiece, the handle comprising a supply line for passage of a cleaning liquid to the liquid entry port;
said handle contains a sonication actuator element to add sonication to the flow of liquid towards the liquid entry port; and wherein:
said headpiece comprises a J-shaped headpiece sized to accommodate sections of upper and lower teeth and gums of a user along at least half the user's jaw.

17. The cleaning device according to claim 16, wherein said headpiece comprises first and second of said J-shaped headpieces pivotally connected at a pivot point, wherein said first and second headpieces can be folded in around said pivot point for insertion into the mouth and unfolded after insertion into the mouth two permit full coverage of the jaws of the user for simultaneous cleaning.

18. The cleaning device according to claim 1, wherein said headpiece arrangement comprises first and second of said headpieces,
wherein said headpieces can be alternatingly supplied with pressurized cleaning liquid, wherein said partial headpieces are formed essentially each in mirrored J-shape, each allowing covering approximately at least half the user's jaw,
wherein said headpieces are arranged such that the first headpiece can act as an active headpiece when inserted in the user's mouth, whereas the second headpiece can act as a passive headpiece outside the user's mouth.

19. The cleaning device according to claim 1, further comprising a liquid supply coupleable to the liquid entry port having a cleaning position for said headpiece and wherein before or after use the liquid supply can circulate water or cleaning fluid through the headpiece for flushing purposes.

20. A method for cleaning teeth and gums using a cleaning headpiece which addresses a plurality of teeth of a user's jaw simultaneously, wherein said headpiece is rigidly connected to a handle, said headpiece comprising a plurality of fluid cleaning nozzles, resilient flexures, fluid draining capability and a geometry with sufficient gaps between the cleaning headpiece and the user's jaws and wherein the user moves the headpiece's cleaning nozzles relatively up and down with respect to their teeth height by pressing down on flexures and wherein the user moves the headpiece in mesial and distal directions of their teeth by controlling the handle position.
